(19) United States
(12) Patent Application Publication
(10) Pub. No.: US 2009/0208210 A1
(43) Pub. Date: Aug. 20, 2009

(54) PASSIVE OPTICAL NETWORK REMOTE PROTOCOL TERMINATION

(76) Inventors: Elmar Trojer, Stockholm (SE); David Hood, Palo Alto, CA (US)

Correspondence Address: ERICSSON INC., 6300 LEGACY DRIVE, M/S EVR 1-C-11, PLANO, TX, 75024, US

(21) Appl. No.: 12/032,881

(22) Filed: Feb. 18, 2008

(51) Int. Cl. H04B 10/20

(52) U.S. Cl. 398/58

(57) ABSTRACT

A system, method, and node for extending the reach of a fiber-based access network. A Remote Protocol Termination (RPT) is implemented remotely from a central office Optical Line Termination (OLT). The RPT receives a data signal transmitted by a user's Optical Network Unit/Termination (ONU/T) over a Passive Optical Network (PON) utilizing a PON protocol or Wavelength Division Multiplexing (WDM)_based protocol, and converts the signal to a long-reach transport protocol. The RPT then transmits the data signal to the central office OLT utilizing the long-reach transport protocol. The RPT also performs this protocol conversion in the opposite direction for signals transmitted from the central office OLT to the ONU/T.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to fiber-optics communication networks. More particularly, and not by way of limitation, the present invention is directed to a system, method, and node for extending the reach of a fiber-based access network.

The following abbreviations are utilized in the background and description herein:
3R Reshaping, Reamplifying, Retiming
10GE Ten Gigabit Ethernet
APD Avalanche Photo Diode
BPON Broadband PON
CDR Clock and Data Recovery
DBA Dynamic Bandwidth Assignment
DWDM Dense Wavelength Division Multiplexing
EDFA Erbium Doped Fiber Amplifier
EPON Ethernet PON
FTTx Fiber To The X
GbE Gigabit Ethernet
GEM GPON Encapsulation Method
GPON Gigabit PON
GTC GPON Transmission Convergence
MAC Media Access Control
NGA Next Generation Access
ODN Optical Distribution Network
OEO Optical Electrical Optical
OLT Optical Line Termination
OMCI ONT Management Control Interface
ONT Optical Network Termination
ONU Optical Network Unit
OPU Optical Channel Payload Unit
OTN Optical Transport Network
OTU Optical Channel Transport Unit
PIN PD PIN photo diode (positive-intrinsic-negative)
PMD Physical Media Dependent
p2mp Point-to-Multipoint
p2p Point-to-Point
PON Passive Optical Network
QoS Quality of Service
RN Remote Node
RPT Remote Protocol Termination
RSTP Rapid Spanning Tree Protocol
SDH Synchronous Digital Hierarchy
SERDES Serialize-Deserialize
SOA Semiconductor Optical Amplifiers
SONET Synchronous Optical Network
TDM Time Division Multiplexing
TDMA Time Division Multiple Access
WDM Wavelength Division Multiplexing
XAUI X Attachment Unit Interface protocol
XFP Small Form Factor Pluggable Module
μTCA Micro Telecom Computing Architecture

There is a growing demand for higher speeds (100 Mbps per user) in access networks to enable network operators to provide more broadband services. To meet these needs, there is increased interest in fiber-based access technologies. Optical access networks can be split into two families depending on whether the Optical Distribution Network (ODN) contains active equipment or not. The ODN is the fiber network between an Optical Line Termination (OLT) at the central office and the Optical Network Unit or Termination (ONU/T) at the customer's premises. When the ODN is totally passive, the system is called a Passive Optical Network (PON), which mainly exists in a Point-to-Multipoint (p2mp) architecture. Point-to-Point (p2p) structures are also available, for example in fiber-based Ethernet architectures.

PONs have gained great attention in the last few years due to their low cost (p2mp implies a fiber-frugal tree topology), low maintenance (no remote powering in the Fiber-to-the-Home (FTTH) configuration), and high reliability (high mean time between failures due in large part to having no active parts). A PON essentially provides an optical tree ODN: a single common trunk fiber from the central OLT going to a passive power splitter where optical signals are forked out onto a plurality of individual drop fibers, each of which goes to an ONU/T. The passive power splitter is usually placed at a Remote Node (RN) in the field.

All existing systems use a single fiber for both the upstream and downstream directions, with upstream and downstream signals being transmitted on separate wavelengths. Downstream data is broadcast from the OLT to each ONU/T, and each ONU/T processes the data destined to it by matching the address at the protocol header. Upstream traffic from each of the ONU/Ts to the OLT must be coordinated to avoid collisions due to the shared media nature of the ODN. Upstream data is transmitted in bursts according to a bandwidth map sent from the OLT, using a Time Division Multiple Access (TDMA) protocol in which dedicated transmission time slots are granted to each individual ONU/T. The time slots are then synchronized so that transmission bursts from different ONU/Ts do not collide at the OLT receiver.

The OLT, being responsible for controlling the upstream bandwidth allocation, can also utilize Dynamic Bandwidth Assignment (DBA) to dynamically reallocate bandwidth according to provisioned parameters of the various services and according to the upstream traffic offered at any given time at the various ONU/Ts. The OLT sends data downstream to all ONU/Ts via the ODN using Time Division Multiplexing (TDM).

There are currently three alternative PON implementation technologies: Ethernet PON (EPON), Broadband PON (BPON), and Gigabit PON (GPON) with 10 Gbps extensions in standardization. Characteristics of these three PON technologies are summarized in Table 1 below. All of these technologies share a common network topology, but differ in their transmission protocols and performance.

TABLE 1

| Characteristics | EPON | BPON | GPON |
|---|---|---|---|
| Standard | IEEE 802.3ah | ITU-T G.983 | ITU-T G.984 |
| Protocol | Ethernet | ATM | Ethernet |
| Bit Rates (Mbps) | 1244 up/ | 155 up/ | 1244 up/ |
| | 1244 down | 622 down | 2488 down |
| Span (km) | 10 | 20 | 20 |
| Number of Splits | 16 | 32 | 64 |

As can be seen, GPON as a successor of BPON is the most advanced system in terms of bit rates (1244 Mbps up and 2488 Mbps down in practical systems), the total span (trunk plus drop span), and the number of users (splits) per OLT.

FIG. 1 is a simplified block diagram of a typical existing GPON system configuration 10. There are, of course, optical losses in this passive network, which limit the reach of the GPON system. The reach is actually limited in two ways. First the total reach (trunk span from the OLT 11 to the splitter 12 plus drop span from the splitter 12 to the farthest ONU 13) must be less than 60 km in logical reach, as determined by round-trip propagation delay. Second, the optical budget limits the physical reach to about 20 km, depending on split ratio, optical connectorization, and the like. The ranging procedure also requires the maximum differential distance between the farthest ONU 13 and the nearest ONU 14 to be less than 20 km.

There are several proposed methodologies for extending the reach and/or split ratio of GPON systems. One such methodology is a bidirectional PON extender box providing pure optical amplification in both the upstream and the downstream directions. In a pure optical amplifier, differences in the signal strengths of the transmissions from the various ONUs are carried forward from the amplifier on the fiber trunk going to the OLT receiver. A second methodology is a bidirectional PON extender box providing Optical-to-Electrical-to-Optical (OEO) conversion, where the electrical part of the box re-times and re-shapes the signal. In an OEO extender, the optical signal going to the OLT is regenerated by the extender, and therefore has a constant power level and constant phase regardless of the phase and relative signal strengths of the ONUs it is repeating. The OEO extender is located in the field (mid-span extender), in the trunk fiber, typically at or near the power splitter location.

### SUMMARY

Operators need a total reach and/or a split ratio that exceeds the present capabilities of PON systems. All of the proposed methodologies for increasing the total reach and/or split ratio, however, require an optical extender box in a remote node location. The use of a remote optical extender box introduces a number of challenges relating to powering, extender box management and alarming, GPON framing changes (long upstream preamble needed), transparency/support of optical supervision, and feeder protection switching. These issues may require changes of the standard GPON system that are costly and may delay deployment.

It would be advantageous to have a system and method that overcomes the disadvantages of the prior art by extending the reach and split ratio of a PON without the use of a remote optical or OEO (regenerator) extender box. The present invention provides such a system and method utilizing a device referred to as a PON Remote Protocol Termination (RPT). The RPT is located remotely from a core network access node referred to herein as the central office OLT, but unlike optical extender boxes, the RPT terminates PON (or WDM) transmissions from the ONU/Ts and converts the transmissions to a long-reach backhaul transport protocol for transmission to the central office OLT. Thus, in the context of the present invention, the central office OLT no longer terminates the PON or WDM protocol, but merely performs as an access node.

The RPT may terminate any type of optical transport protocol utilized on the distribution side of the RPT. For example, various PON protocols such as GPON G.984.3, EPON IEEE802.3ah (1/1G EPON), or IEEE802.3av (10/1G XEPON) may be utilized. Additionally, WDM-based protocols (also referred to as Dense Wavelength Division Multiplexing (DWDM)) may be utilized. In the embodiments described herein, GPON is utilized as an example due to its superiority over other PON protocols in terms of bit rates, total span, and the number of users (splits) per OLT.

The side of the RPT toward the ONU/Ts is an unchanged GPON, which communicates with the ONU/Ts using, for example, standard GPON data signals such as ITU-T G.984 GPON Encapsulation Method (GEM) data signals. Thus, the RPT benefits from existing components, systems, and engineering practices. The side of the RPT toward the central office OLT communicates with a long-reach backhaul transport protocol such as GbE, 10GE, the Synchronous Digital Hierarchy/Synchronous Optical Network (SDH/SONET) protocol, or WDM-based transport technologies. The RPT includes a bi-directional protocol converter. This extends the physical reach of the GPON up to the limit of the backhaul transport protocol (many tens of km), and also provides entry into networks such as metro Ethernet rings, which provide improved redundancy and survivability.

Thus, in one embodiment, the present invention is directed to a protocol termination node for extending the reach of a fiber-based access network, wherein the access network extends from a core network access node to a plurality of user terminals, and the protocol termination node is remotely located from the access node. The protocol termination node includes means for receiving a data signal transmitted by a user terminal over a distribution portion of the access network utilizing an optical transport protocol; means for converting the signal from the optical transport protocol to a long-reach transport protocol; and means for transmitting the data signal to the access node utilizing the long-reach transport protocol. In one embodiment, the access node is an Optical Line Termination (OLT) at a central office, and the distribution portion of the access network is a Passive Optical Network (PON), which utilizes a PON protocol. In the opposite direction, the protocol termination node receives a data signal transmitted by the access node utilizing the long-reach transport protocol and converts the signal to the optical transport protocol utilized in the distribution portion of the network. The node then transmits the signal to the user terminal utilizing the optical transport protocol.

In other embodiments, the present invention is directed to a system and method for extending the reach of a fiber-based access network. The system includes a core network access node for transmitting and receiving data signals utilizing a long-reach transport protocol, and a protocol termination node in communication with the access node. The protocol termination node is remotely located from the access node and includes means for transmitting and receiving data signals to and from the access node utilizing the long-reach transport protocol; means for transmitting and receiving data signals to and from a user terminal over a distribution portion of the access network utilizing an optical transport protocol; and means for converting between the long-reach transport protocol and the optical transport protocol utilized in the distribution portion of the access network. The converting means may include means for encapsulating and decapsulating Ethernet frames.

### BRIEF DESCRIPTION OF THE SEVERAL VIEWS OF THE DRAWING

In the following section, the invention will be described with reference to exemplary embodiments illustrated in the figures, in which:

FIG. 1 (Prior Art) is a simplified block diagram of an existing fiber-based access system;

FIG. 2 is a simplified functional block diagram of a fiber-based access system according to an embodiment of the present invention;

FIG. 3 is a simplified functional block diagram of a Remote Protocol Termination (RPT) unit according to an embodiment of the present invention;

FIG. 4 is a simplified functional block diagram of the GPON Transmission Convergence (GTC) portion of an access board in the RPT unit according to an embodiment of the present invention.

FIG. 5 is an illustrative drawing of a protocol stack illustrating the encapsulation and decapsulation of Ethernet frames in the RPT unit;

FIG. 6 is a flow chart illustrating the steps of an exemplary embodiment of the method of the present invention when handling an upstream data flow from an ONU/T to the central office OLT; and

FIG. 7 is a flow chart illustrating the steps of an exemplary embodiment of the method of the present invention when handling a downstream data flow from the central office OLT to an ONU/T.

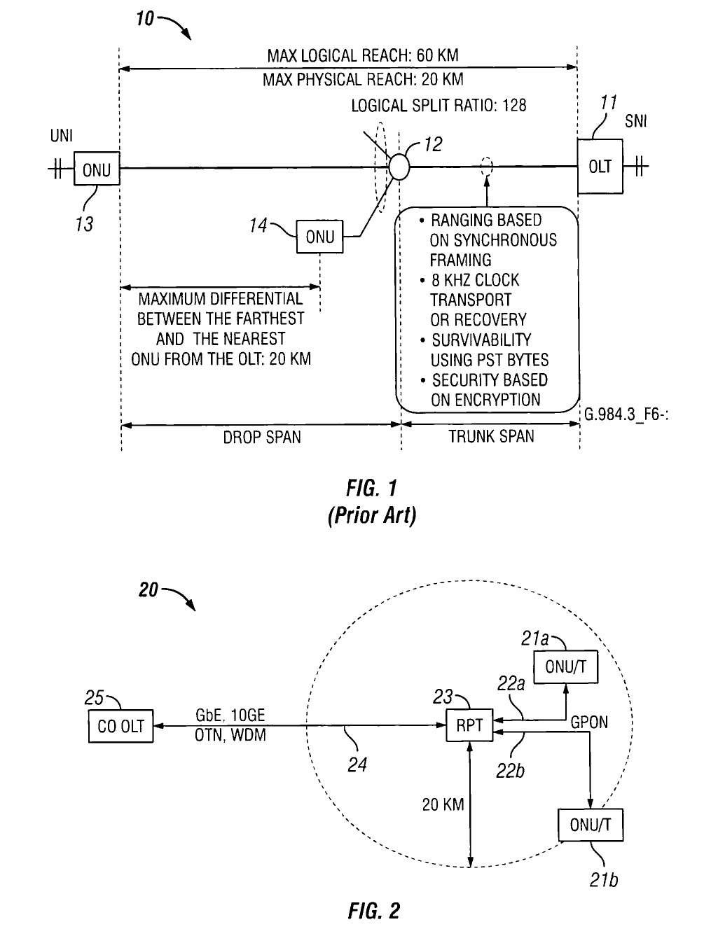

### DETAILED DESCRIPTION

The PON Remote Protocol Termination (RPT) of the present invention provides the advantages of an OEO extender, but does not simply repeat bit streams through an electrical regenerator circuit. Instead, the RPT terminates the PON protocol on the distribution side facing the ONU/Ts, and converts the PON protocol to a long-reach backhaul transport protocol independent of the PON protocol for the trunk link to the central office OLT. Although any commercially standard (or proprietary) protocol suitable for the purpose may be utilized within the scope of the invention, the exemplary embodiment described herein may utilize 2.5 G GPON, 10 G GPON, or Wavelength Division Multiplexing (WDM)-based protocols on the distribution side facing the ONU/Ts, and may utilize 10GE, GbE, SDH/SONET, or a WDM-based backhaul protocol, for example, for the trunk link.

An advantage of the present invention is that the ONU/Ts and the PON protocol downstream from the RPT are completely standard and require no modification. Reach is decoupled from round-trip delay time. Likewise, the uplink can be selected from a completely standard family. Protocols, technology, and products widely and cost-effectively available today can be utilized whether the uplink is 10GE, GbE, OTN SDH/SONET, or a WDM-based backhaul protocol. A number of features such as WDM, rings, repeaters, dual homing protection, and the like are supportable on one or both of the SDH or GbE technologies, without changing the fundamental specification of the GPON access system.

FIG. 2 is a simplified functional block diagram of a fiber-based access system 20 according to an embodiment of the present invention. In the upstream direction. ONU/Ts 21a and 21b transmit GPON GEM signals 22a and 22b to the RPT 23. This access distance is limited by the PON protocol to a maximum of approximately 20 km. The RPT decapsulates the GPON GEM signals to produce Ethernet frames for handling by an internal Ethernet switch and sends a signal 24 to a Central Office (CO) OLT 25 utilizing 10GE, GbE, OTN SDH/SONET, or a WDM-based backhaul protocol for transmission. This significantly extends the reach of the system beyond the capabilities of existing PON architectures. As an example, with SFP/XFP-based long reach options for GbE and 10GE (up to 85 km), the invention provides an increase in reach from 20 km (standard GPON reach) to 105 km (standard GPON including backhaul). Since GPON supports 20 km differential reach, in this example the RPT provides the coverage options as depicted in FIG. 2.

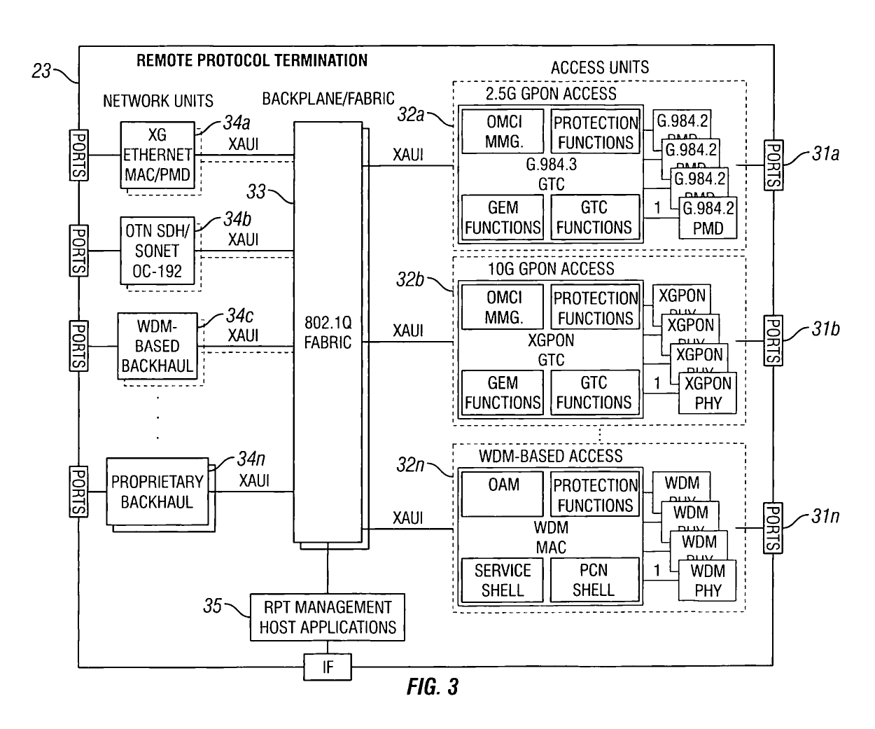

FIG. 3 is a simplified functional block diagram of the RPT 23 according to an embodiment of the present invention. A number of distribution-side ports 31a-31n communicate with ONU/Ts (not shown). The ports connect to a number of access units 32a-32n. Each access unit may handle a different access technology such as 2.5 G GPON access, 10 G PON access, WDM-based access, and the like, or the access units may all handle the same access technology. The access units convert in both directions between Ethernet and the distribution protocol as utilized in the PON. In this embodiment, the access units connect for example to an 802.1Q Ethernet backplane/fabric 33 using the X Attachment Unit Interface (XAUI) protocol as defined by the IEEE 802.3 10 GbE specification. This protocol is used both as a lightweight point-to-point transmission interface, and as the physical layer for 10 Gigabit Ethernet packetized communication. The backplane/fabric performs 802.1Q switching, including VLAN tagging and stripping, link aggregation, protection, rapid spanning tree protocol (RSTP) functions, and the like. Since traffic of several PONs can be concentrated with different overbooking rations towards the backhaul interfaces, Quality of Service (QoS) for the traffic can be supported by the RTP as well.

The Ethernet backplane/fabric 33 uses the XAUI protocol to connect to a number of network units 34a-34n. The network units contain the MAC and physical layers to backhaul the traffic utilizing network protocols such as 10GE, OTN SDH/SONET, WDM-based backhaul, proprietary backhaul, and the like. RPT management host applications 35 may be controlled from the central office OLT 25.

If 10GE is utilized, up to four GPON ports can be backhauled with a single 10GE uplink connection. Within the RTP, traffic from different PONs can be concentrated to a backhaul interface providing typical Ethernet QoS features. The RPT may connect to the OLT 25 utilizing a 10 GE blade in the OLT. The OLT blade does not have to know anything about the G.984 GPON protocol since the RPT has already performed the protocol conversion.

The RPT is capable of performing burst reception and compensating for ranging and delays. The RPT can also pack and unpack GEM frames, and perform DBA. No switching, tagging, or snooping are required. The distribution side of the RPT toward the ONU/Ts may be a standard GPON (for example) with 28 dB of budget to allocate between reach and splitter.

At the central office end of the backhaul connection, the feeder terminates conceptually into the backplane of the OLT, where traffic management, element management, and other features reside. Vendors who encapsulate all GEM traffic in Ethernet frames can simply copy these Ethernet frames to GbE or 10GE uplinks. Vendors using the SDH GEM mapping can preferably utilize SDH in the uplink.

Utilizing either GbE or SDH in the uplink provides several implementation advantages:

(1) Long-reach optics are readily available;

(2) If several uplinks are to be multiplexed onto the same feeder, WDM technology in transport applications is also well-defined and available;

(3) Protection is well understood, particularly in SDH, and is being developed for other Ethernet applications via link aggregation or RSTP; and

(4) Synchronization is easily accomplished with an SDH uplink. On the Ethernet side, synchronous Ethernet may be utilized.

If the ONT Management Control Interface (OMCI) is utilized, the RPT 23 is transparent, and thus to manage the ONU/Ts 21a, 21b, the OLT can pack OMCI tasks into Ethernet frames and address them to the RPT MAC address for relay to the ONU/Ts.

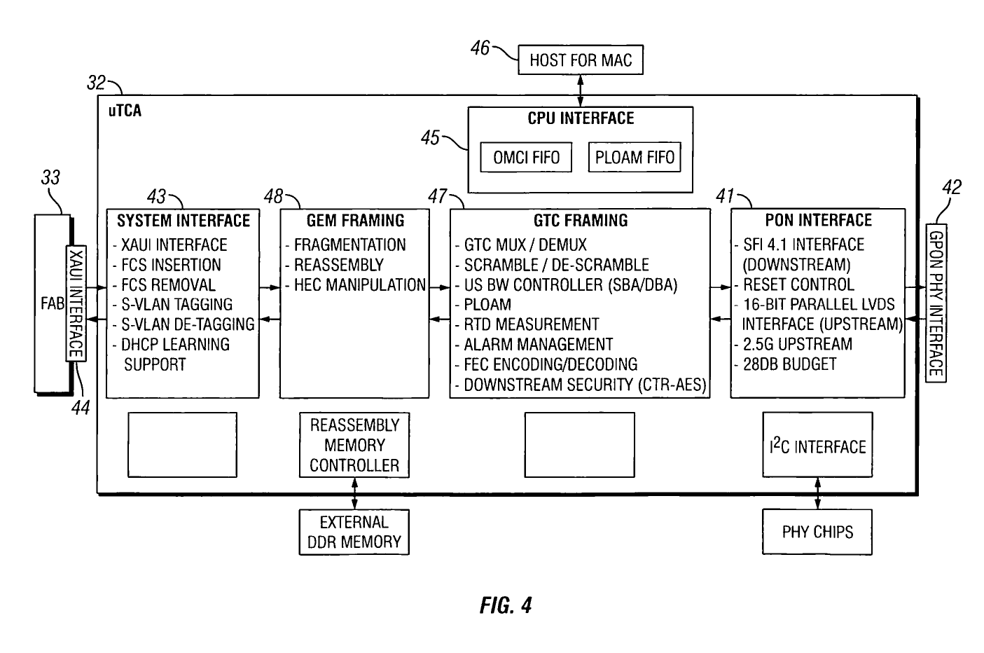

FIG. 4 is a simplified functional block diagram of the GPON Transmission Convergence (GTC) portion of an access unit 32 in the RPT 23 according to an embodiment of the present invention. The access unit may be implemented, for example, on a Micro Telecom Computing Architecture (μTCA) board. The functional blocks include a PON interface 41 for interfacing with the GPON PHY interface 42, a system interface 43 for interfacing with the XAUI interface 44 leading to the Ethernet backplane/fabric 33, and a CPU interface 45 for interfacing with a host processor 46. In the upstream and downstream path, there are a GTC framing unit 47 and a GPON Encapsulation Method (GEM) framing unit 48. Together with the PON interface and the system interface, the GTC and GEM framing units terminate the PON-specific G984.3 TDM/TDMA protocol as utilized in the GPON and decapsulate the signal to produce Ethernet frames for use in the 802.1Q Ethernet backplane/fabric 33. Exemplary functions performed by each interface and framing unit are shown in more detail in FIG. 4.

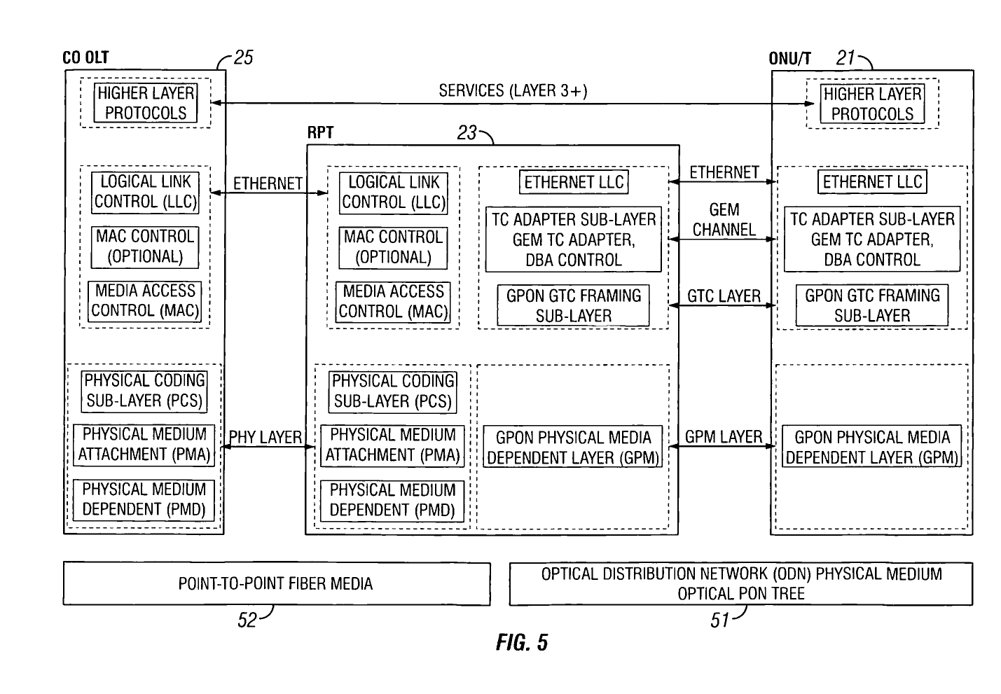

FIG. 5 is an illustrative drawing of a protocol stack illustrating the encapsulation and decapsulation of Ethernet frames in the RPT unit 23. As can be seen, all of the immediate low-layer functions of the distribution network 51 (for example, GPON) are localized to and between the RPT 23 and the ONU/T 21. The central office OLT 25 and the connection 52 between the RPT and the OLT (for example, a p2p fiber media trunk) are independent of these functions. The remaining higher level and management functions are more easily supported from a greater distance over an arbitrary interconnection network.

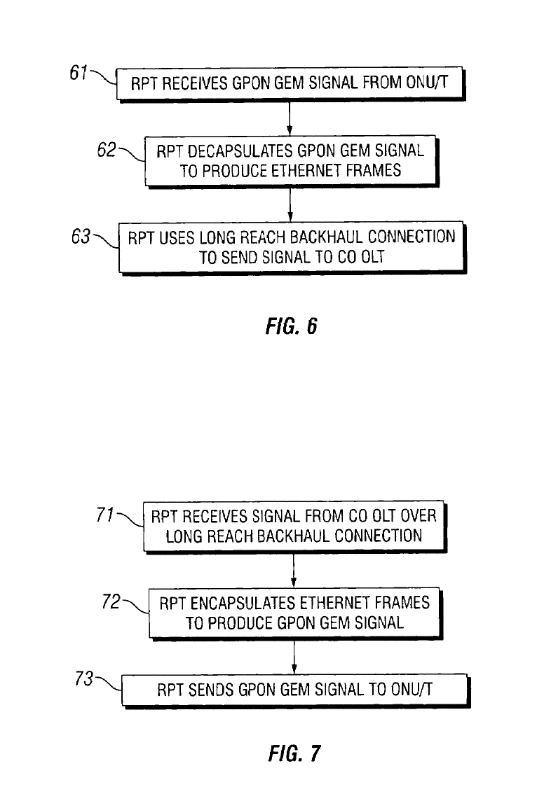

FIG. 6 is a flow chart illustrating the steps of an exemplary embodiment of the method of the present invention when handling an upstream data flow from an ONU/T 21 to the central office OLT 25. At step 61, the RPT receives a signal such as a GPON GEM signal from an ONU/T. At step 62, the RPT access unit 32 decapsulates the GPON GEM signal to produce Ethernet frames, and provides the frames to the 802.1Q backplane/fabric 33. At step 63, a network unit 34 in the RPT sends the signal to the central office OLT over a long-reach backhaul connection.

FIG. 7 is a flow chart illustrating the steps of an exemplary embodiment of the method of the present invention when handling a downstream data flow from the central office OLT 25 to an ONU/T 21. At step 71, the network unit 34 in the RPT receives a signal from the central office OLT over the long reach backhaul connection and provides it to the 802.1Q backplane/fabric 33. The backplane/fabric provides the signal to the access unit 32, which encapsulates the Ethernet signal into a signal such as a GPON GEM signal at step 72. At step 73, the RPT sends the GPON GEM signal to the ONU/T 21.

The present invention greatly simplifies the problem of optical extender box management and alarming, which is complicated in proposed prior art solutions. In those solutions with an optical extender box inside the GPON, OMCI must manage the box (i.e., a standards update is necessary). In the present invention, the RPT may be managed from the central office OLT via the backhaul Ethernet link by whatever management system protocol (OSS) is utilized. Additionally, prior art solutions suffer from problems associated with optical supervision via optically amplified PONs or repeated PONs due to problems supporting out-band measurements on non-GPON wavelength and the more difficult interpretation of measurement results. With the RPT of the present invention, the GPON ODN is unchanged and optical supervision on 28 dB is easily achieved. The invention also eliminates the need for GPON framing changes, and enables feeder protection switching to be performed.

Other Advantages of the Invention Include:

Utilizes standard components;

Only minimal hardware modification to the OLT and ONU/T system is necessary;

Provides long reach (100+km);

Provides distribution side multiplexing on a single trunk fiber;

Decouples Reach/Delay;

Provides a cost-efficient solution; and

Supports trunk protection.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A protocol termination node for extending the reach of a fiber-based access network, wherein the access network extends from a core network access node to a plurality of user terminals, wherein the protocol termination node is remotely located from the access node and comprises:
means for receiving a data signal transmitted by a user terminal over a distribution portion of the access network utilizing an optical transport protocol;
means for converting the signal from the optical transport protocol to a long-reach transport protocol; and
means for transmitting the data signal to the access node utilizing the long-reach transport protocol.

2. The protocol termination node as recited in claim 1, wherein the protocol termination node is a bi-directional protocol termination node, wherein the converting means also includes means for converting the long-reach transport protocol to the optical transport protocol for data signals transmitted from the core network access node to the user terminal.

3. The protocol termination node as recited in claim 2, wherein the optical transport protocol is selected from a group consisting of:
ITU-T G.984 Gigabit PON (GPON);
10 Gigabit GPON;
Ethernet PON (EPON); and
a Wavelength Division Multiplexing (WDM)-based protocol.

4. The protocol termination node as recited in claim 2, wherein the long-reach transport protocol is selected from a group consisting of:
10 Gigabit Ethernet (10GE);
Gigabit Ethernet (GbE);
Synchronous Digital Hierarchy/Synchronous Optical Network (SDH/SONET); and
a Wavelength Division Multiplexing (WDM)-based backhaul protocol.

5. The protocol termination node as recited in claim 2, wherein the data signal received from the user terminal is a PON-specific time division multiplexed (TDM) signal, and the converting means includes means for decapsulating Ethernet frames from the PON-specific TDM signal for transmission to the access node.

6. The protocol termination node as recited in claim 5, wherein the converting means also includes means for encapsulating Ethernet frames into a PON-specific TDM signal for transmission to the user terminal.

7. The protocol termination node as recited in claim 6, wherein the PON-specific TDM signal is a Gigabit Passive Optical Network Encapsulation Method (GPON GEM) signal.

8. A method of extending the reach of a fiber-based access network that extends from a core network access node to a plurality of user terminals, said method comprising the steps of:
implementing a protocol termination node remotely from the core network access node;
receiving at the protocol termination node, a data signal transmitted by a user terminal over a distribution portion of the access network utilizing an optical transport protocol:
converting the signal from the optical transport protocol to a long-reach transport protocol; and
transmitting the data signal to the access node utilizing the long-reach transport protocol.

9. The method as recited in claim 8, wherein the optical transport protocol is selected from a group consisting of:
ITU-T G.984 Gigabit PON (GPON);
10 Gigabit GPON;
Ethernet PON (EPON); and
a Wavelength Division Multiplexing (WDM)-based protocol.

10. The method as recited in claim 8, wherein the long-reach transport protocol is selected from a group consisting of:
10 Gigabit Ethernet (10GE);
Gigabit Ethernet (GbE);
Synchronous Digital Hierarchy/Synchronous Optical Network (SDH/SONET); and
a Wavelength Division Multiplexing (WDM)-based backhaul protocol.

11. The method as recited in claim 8, wherein the data signal received from the user terminal is a PON-specific time division multiplexed (TDM) signal, and the step of converting the signal from the optical transport protocol to the long-reach transport protocol includes decapsulating Ethernet frames from the PON-specific TDM signal for transmission to the access node.

12. A method of extending the reach of a fiber-based access network that extends from a core network access node to a plurality of user terminals, said method comprising the steps of:
implementing a protocol termination node remotely from the core network access node;
receiving at the protocol termination node, a data signal transmitted by the core network access node utilizing a long-reach transport protocol;
converting the signal from the long-reach transport protocol to an optical transport protocol utilized in a distribution portion of the access network; and
transmitting the data signal to an addressed user terminal over the distribution portion of the access network utilizing the optical transport protocol.

13. The method as recited in claim 12, wherein the optical transport protocol utilized in the distribution portion of the access network is selected from a group consisting of:
ITU-T G.984 Gigabit PON (GPON);
10 Gigabit GPON;
Ethernet PON (EPON); and
a Wavelength Division Multiplexing (WDM)-based protocol.

14. The method as recited in claim 12, wherein the long-reach transport protocol is selected from a group consisting of:
10 Gigabit Ethernet (10GE);
Gigabit Ethernet (GbE);
Synchronous Digital Hierarchy/Synchronous Optical Network (SDH/SONET); and
a Wavelength Division Multiplexing (WDM)-based backhaul protocol.

15. The method as recited in claim 12, wherein the converting step includes utilizing the Gigabit PON (GPON) Encapsulation Method (GEM) to encapsulate Ethernet frames into a PON-specific time division multiplexed (TDM) protocol.

16. A system for extending the reach of a fiber-based access network, said system comprising:
a core network access node for transmitting and receiving data signals utilizing a long-reach transport protocol; and
a protocol termination node in communication with the access node, wherein the protocol termination node is remotely located from the access node and comprises:
means for transmitting and receiving data signals to and from the access node utilizing the long-reach transport protocol;
means for transmitting and receiving data signals to and from a user terminal over a distribution portion of the access network utilizing an optical transport protocol;
means for converting data signals received from the access node from the long-reach transport protocol to the optical transport protocol utilized in the distribution portion of the access network for transmission to the user terminal; and
means for converting data signals received from the user terminal from the optical transport protocol utilized in the distribution portion of the access network to the long-reach transport protocol for transmission to the access node.

17. The system as recited in claim 16, wherein the optical transport protocol utilized in the distribution portion of the access network is a Passive Optical Network (PON) protocol selected from a group consisting of:
ITU-T G.984 Gigabit PON (GPON);
10 Gigabit GPON;
Ethernet PON (EPON); and
a Wavelength Division Multiplexing (WDM)-based protocol.

18. The system as recited in claim 16, wherein the long-reach transport protocol is selected from a group consisting of:
10 Gigabit Ethernet (10GE);
Gigabit Ethernet (GbE);
Synchronous Digital Hierarchy/Synchronous Optical Network (SDH/SONET); and
a Wavelength Division Multiplexing (WDM)-based backhaul protocol.

19. The system as recited in claim 16, wherein the means for converting data signals received from the access node includes means for utilizing the Gigabit PON (GPON) Encapsulation Method (GEM) to encapsulate Ethernet frames into a PON-specific time division multiplexed (TDM) protocol for transmission to the user terminal.

20. The system as recited in claim 16, wherein the data signals received from the user terminal are PON-specific time division multiplexed (TDM) signals, and the means for converting data signals received from the user terminal includes means for decapsulating Ethernet frames from the PON-specific TDM signal for transmission to the access node.
